(19) United States
(12) Patent Application Publication
(10) Pub. No.: US 2011/0038487 A1
(43) Pub. Date: Feb. 17, 2011

(54) EARPHONE ACOUSTIC SIMULATION SYSTEM AND OPTIMAL SIMULATION METHOD OF THE SAME

(75) Inventors: MINGSIAN R. BAI, Hsinchu City (TW); YU-CHIH KUO, Hsinchu City (TW)

Correspondence Address: ROSENBERG, KLEIN & LEE, 3458 ELLICOTT CENTER DRIVE-SUITE 101, ELLICOTT CITY, MD, 21043, US

(73) Assignee: NATIONAL CHIAO TUNG UNIVERSITY, Hsinchu City (TW)

(21) Appl. No.: 12/645,581

(22) Filed: Dec. 23, 2009

(30) Foreign Application Priority Data
Aug. 14, 2009 (TW) 098127363

(51) Int. Cl. H04R 29/00

(52) U.S. Cl. 381/58

(57) ABSTRACT

An earphone acoustic simulation system and an optimal simulation method of the same is disclosed. The earphone acoustic simulation system comprises an earphone front end simulation circuit and an earphone back end simulation circuit for simulating acoustic environment of a front cavity and a back cavity inside an earphone, and an artificial ear simulation circuit is connected respectively with the earphone front end simulation circuit and the earphone back end simulation circuit. Variation of an impedance of the artificial ear simulation circuit represents the frequency response in the earphone cavity. Besides, the optimal simulation of the earphone acoustic simulation system utilizes simulated annealing algorithm to obtain the optimal parameter of the earphone cavity, and anticipates the SPL curve related to the optimal earphone cavity through utilizing the earphone acoustic simulation system.

### BACKGROUND OF THE INVENTION

1. Field of the Invention

The present invention relates to an acoustic simulation system, and in particular to a simulation platform of earphone acoustic space.

2. Description of the Related Art

Earphone is a kind of acoustic product, which can broadcast sound into the ears for listening. During the development period of sound amplification technology, new earphone technology has combined broadcast function with bluetooth function in adding a new advantage—hands free communication, which can assist in reproducing speech or cell phone voice. It has resulted in a growing market demand for this kind of earphone.

The prerequisite of good earphones is that, the signal transmitted in the form of current is transformed into acoustic wave to the human ear without any distortion. Because an earphone has various conflicting problems arising from sensitivity, distortion, bandwidth, and size miniaturization requirements, they all influence the sound quality produced when the earphone functions. Moreover, in order to simulate a loudspeaker in an open space, an Electro-Mechanical-Acoustical analog circuit is used to predict the frequency response for the loudspeaker in the prior art. Also, the optimal structure parameters can be calculated by algorithms using the EMA analog circuit for designing the loudspeakers. However, this kind of simulation platform for earphones simply does not exist. Because earphones, their associated enclosure and casing create an acoustic environment different from that of an open space of loudspeakers, therefore, it is desirable to develop a systematic and efficient way to attain the design that would meet the requirements of good earphones.

Due to the shortcomings of the prior art, the present invention presents an earphone acoustic simulation system and an optimal simulation method of the same.

### SUMMARY OF THE INVENTION

A primary objective of the present invention is to provide an earphone acoustic simulation system and an optimal simulation method of the same. The present invention establishes a frequency response simulation platform of an earphone and an ear canal to provide the numerical value of the simulated sound effect for the application of earphone designers.

Further, the present invention establishes an earphone simulation circuit, calculates the optimal earphone cavity parameters by utilizing a simulated annealing (SA) method, and anticipates the result of the earphone optimal design in order to assist the designers in designing the earphone structure.

To achieve the above-mentioned objective, the present invention proposes an earphone acoustic simulation system, which is formed by connecting an acoustic source, an earphone front end simulation circuit, an artificial ear simulation circuit, and an earphone back end simulation circuit together into forming a loop. An acoustic signal is generated by an acoustic source. The earphone front end simulation circuit transmits a voltage signal to the artificial ear simulation circuit. The earphone back end simulation circuit receives the voltage signal from the artificial ear simulation circuit and sends the voltage signal back to the acoustic source. Wherein, the earphone front end simulation circuit includes a first resistance and a duct transmission line T-circuit; the artificial ear simulation circuit includes an ear canal simulation circuit and an ear simulator; the earphone back end simulation circuit is formed by connecting a back cavity simulation circuit and a leakage hole simulation circuit in parallel. Impedance voltages are outputted by the ear canal simulation circuit continuously, and then a sound pressure level (SPL) curve is acquired, which consists of the impedance voltages. The SPL curve acquired from the present invention is similar to a SPL curve in the experimental result. Thereby, the SPL curve acquired from the earphone acoustic simulation system of the present invention can be used to anticipate the frequency response in a cavity of a real earphone.

Additionally, the present invention discloses an optimal simulation method of the earphone acoustic simulation system. Firstly, establish an electro-mechanical-acoustical analog circuit is established, which comprises an earphone acoustic simulation system. In the system, an acoustic source transmits an acoustic signal to an earphone front end simulation circuit; a voltage signal is output by the earphone front end simulation circuit through an artificial ear simulation circuit and an earphone back end simulation circuit and; then the voltage signal is sent back to the acoustic source. Next, the range of a plurality of earphone cavity parameters are set and the impedance voltage from the duct transmission line T-circuit is ouptput to generate a SPL curve. Finally, according to a cost function between the SPL curve and a reference curve of frequency response mask, calculate the optimal design through utilizing simulated annealing method in obtaining optimized earphone cavity parameter values.

It is to be understood that both the foregoing general description and the following detailed description are exemplary, and are intended to provide further explanation of the invention as claimed.

### BRIEF DESCRIPTION OF THE DRAWINGS

The related drawings in connection with the detailed description of the present invention to be made later are described briefly as follows, in which:

FIG. 1 is a cross-section view for an artificial ear connected with a bluetooth earphone according to the present invention;

FIG. 2 is a circuit diagram for an earphone EMA analog circuit according to the present invention;

FIG. 3 is a circuit diagram for an earphone acoustic simulation system according to an embodiment of the present invention;

FIG. 4 is a circuit diagram for an artificial ear simulation circuit according to an embodiment of the present invention;

FIG. 5 is a flowchart for an optimal simulated method of an earphone acoustic simulation system according to the present invention; and

FIG. 6 is a diagram showing SPL curves of simulation vs experiment according to an embodiment of the present invention.

### DETAILED DESCRIPTION OF THE INVENTION

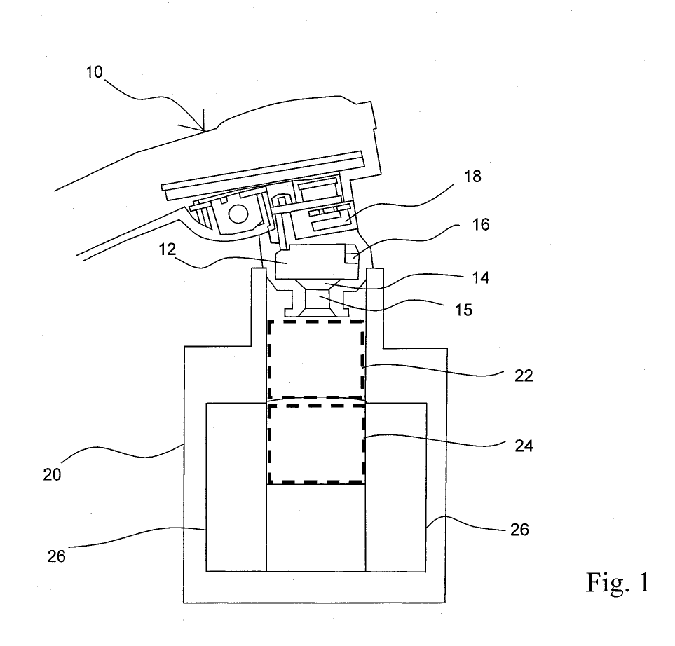

Refer to FIG. 1 for a cross-section view of an artificial ear connected with an earphone which can be a bluetooth earphone. A microspeaker 12 installed in the bluetooth earphone 10 generates an acoustic wave to a front cavity 14 and a back cavity 16 of the earphone. thus causing the two cavities to vibrate. The acoustic wave leaks out from a leakage hole 18 located in the back of the bluetooth earphone. The artificial ear 20 receives the acoustic wave from the front cavity 14 though the duct 15. An external ear canal 22 leads to an internal ear canal 24 in the artificial ear 20. Also, artificial ear simulators 26 are provided respectively in both sides of the internal ear canal 24. Hence, the acoustic environment of the earphone is distinct from the free acoustic field of a loudspeaker. For the earphone structure, the present invention creates an acoustic simulation platform relative to the earphone cavity.

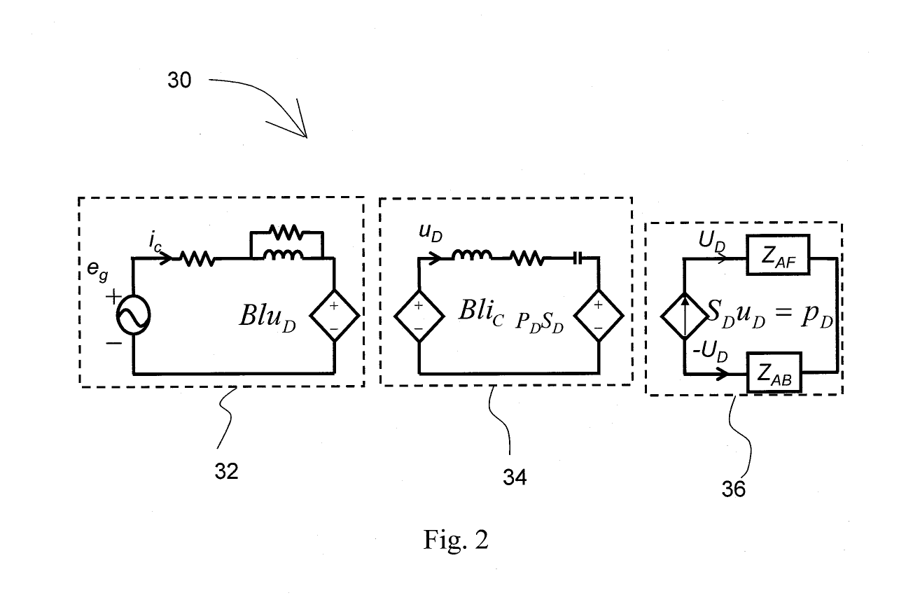

Before disclosing the primary content of the present invention, how the EMA analog circuit simulating the earphone operation is illustrated. The EMA analog circuit 30 is as shown in FIG. 2. The EMA analog circuit 30 is formed by coupling the following three parts: an earphone electrical system 32, a mechanical system 34 and an acoustic simulation system 36, for simulating the earphone operation while it is broadcasting. The electrical system 32 is coupled with the mechanical system 34, and the mechanical system 34 is coupled with the acoustic system 36. The acoustic system 36 is relative to the earphone structure. In order to foresee the frequency response as produced by the earphone structure, the present invention discloses the acoustic simulation system 36 of the EMA analog circuit.

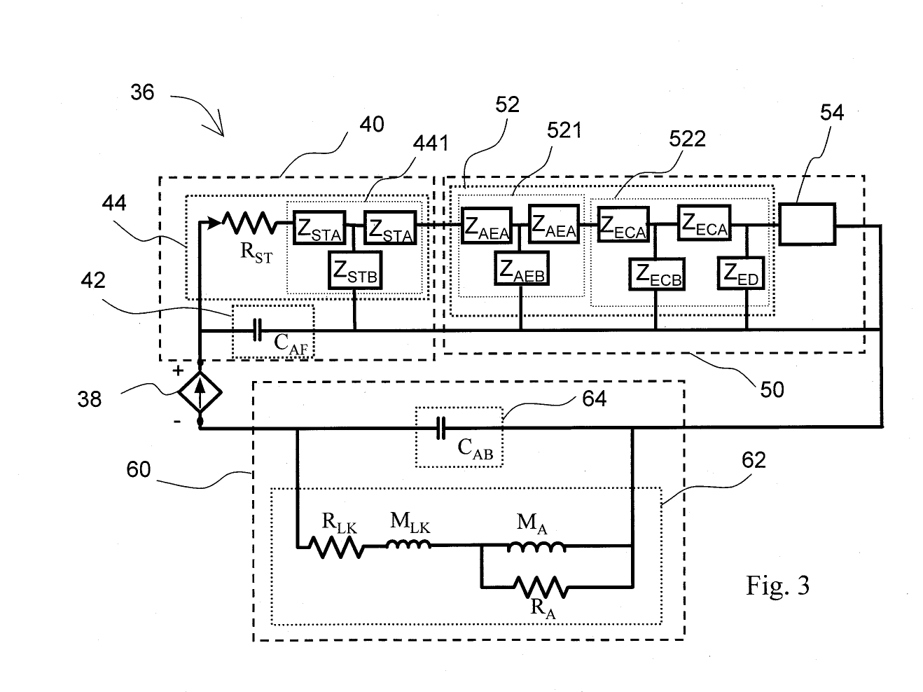

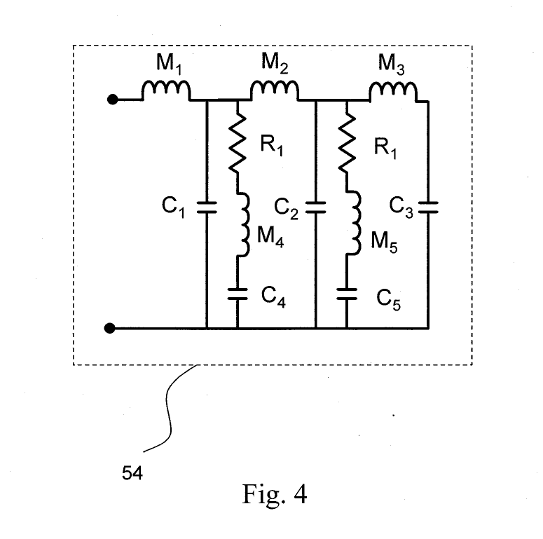

Refer to FIG. 1 and FIG. 3 at the same time, FIG. 3 is a circuit diagram of the earphone acoustic simulation system according to the present invention. In the earphone acoustic simulation system 36, an acoustic source 38, comprising a positive output terminal a negative output terminal, generates an acoustic signal, the acoustic source 38 comprises a positive output terminal and a negative output terminal. The acoustic signal is received by an earphone front end simulation circuit 40 with a front cavity simulation circuit 42 connected with a duct simulation circuit 44 in parallel. The front cavity simulation circuit 42 is a first capacitor C_{AF} for simulating the front cavity 14 in the earphone; the duct simulation circuit 44 is formed by connecting a first resistor R_{ST} and a duct transmission line T-circuit 441 in series, in simulating the duct as a double-opening duct; and two A type duct impedances Z_{STA} are connected with one B type duct impedance Z_{STB} to form the duct transmission line T-circuit 441. The earphone front end simulation circuit 40 outputs a voltage signal to an artificial ear simulation circuit 50 after receiving the acoustic signal. The artificial ear simulation circuit 50 is formed by connecting an artificial ear simulator 54 with an ear canal simulation circuit 52 in series, and an external ear canal simulation circuit 521 is connected with an internal ear canal simulation circuit 522 in parallel. The external ear canal simulation circuit 521 or the internal ear canal simulation circuit 522 is of a T-shape circuit structure. The external ear canal simulation circuit 521 is a T-shape circuit formed by connecting two A type external ear canal impedances Z_{AEA} with one B type external ear canal impedance Z_{AEB}. Likewise, the internal ear canal simulation circuit 522 is a T-shape circuit formed by connecting two A type internal ear canal impedances Z_{ECA} with one B type internal ear canal impedance Z_{ECB}. Also, the internal ear canal simulation circuit 522 further comprises another impedance Z_{ED} that is connected with the T-shape circuit of the internal ear canal circuit 522 in parallel in order to simulate an eardrum of the artificial ear. The value of eardrum impedance Z_{ED} is set as infinite for simulating that one end of the ear canal is closed and the eardrum is rigid. Moreover, an IEC711 simulator is adopted as the artificial ear simulator 54, and the circuit diagram of the IEC711 simulator is as shown in FIG. 4. After passing through the artificial ear simulation circuit 50, the voltage signal is transmitted to an earphone back end simulation circuit 60, which is formed by connecting a leakage hole simulation circuit 62 with a back cavity simulation circuit 64 in parallel. The leakage hole simulation circuit 62 is formed by connecting a second resistor R_{LK} with a first inductor M_{LK} in series for simulating the acoustic environment of sound waves transmitted in the leakage hole 18, and this series connected portion of the circuit is series connected to a second inductor M_{A} and a third resistor R_{A} which are connected to each other in series for simulating radiation generated by air in the leakage hole 18. The back cavity simulation circuit 64 is formed by a second capacitor C_{AB} for simulating the back cavity 16. Hence, the voltage signal passes through the earphone back end simulation circuit 60, and then it is transmitted back to the negative output terminal of the acoustic source 38, such that the earphone acoustic simulation system 36 can form an effective loop circuit.

The first capacitor C_{AF} mentioned above is

$$\frac{{V}_{A}}{{ρ}_{0} {c}^{2}} ,$$

the second capacitor C_{AB} is

$$\frac{{V}_{B}}{{ρ}_{0} {c}^{2}} ,$$

the first inductor M_{LK} is

$$\frac{{ρ}_{0}}{{S}_{LK}} {L}_{LK} ,$$

and the first resistor R_{ST} is

$$\frac{{ρ}_{0}}{π {a}_{ST}} \sqrt{2 ωμ} ( \frac{{L}_{ST}}{{a}_{ST}} + 2 ) .$$

Furthermore, ρ₀ is air density, c is acoustic speed, V_{A} is the volume of the front cavity, S_{LK} is the cross-section area of the leakage hole, L_{LK} is the length of a back duct in the earphone back end, L_{ST} is the length of the duct in the earphone front end, a_{ST} is the radius of the duct and μ is dynamic viscosity.

In addition, the duct transmission line T-circuit is a T-shape circuit for the simulated duct of the earphone, in which a node between two series connected A type duct impedances Z_{STA} is connected with a B type duct impedance Z_{STB}. Wherein, formulas for the A type duct impedance and the B type duct impedance are shown as follows:

$$\begin{matrix}{Z}_{STA} = {jZ}_{0} tan ( \frac{{kL}_{ST}}{2} ) & ( 1 ) \\ {Z}_{STB} = \frac{{Z}_{0}}{j sin ( {kL}_{ST} )} \\ and & ( 2 ) \\ {Z}_{0} = \frac{{ρ}_{0} c}{{a}_{ST}^{2} π} & ( 3 )\end{matrix}$$

In the formulas (1), (2), and (3), L_{ST} is the length of the duct, a_{ST} is the cross-sectional radius of the duct, ρ₀ is air density, and c is acoustic speed. The external ear canal simulation circuit 521 is a T-shape circuit, in which a node between the two series-connected A type external ear canal impedances Z_{AEA} is connected with a B type external ear canal impedance Z_{AEB}. Formulas of the A type external impedance Z_{AEA} and the B type external ear canal impedance Z_{AEB} in the external ear canal simulation circuit are as follows:

$$\begin{matrix}{Z}_{AEA} = {jZ}_{0} tan ( \frac{{kL}_{AE}}{2} ) & ( 4 ) \\ {Z}_{AEB} = \frac{{Z}_{0}}{j sin ( {KL}_{AE} )} \\ and & ( 5 ) \\ {Z}_{0} = \frac{{ρ}_{0} C}{{a}_{AE}^{2} π} & ( 6 )\end{matrix}$$

In the formulas (4), (5) and (6), a_{AE} is the cross-sectional radius of the external ear canal, ρ₀ is air density, c is acoustic speed. Likewise, in the internal ear canal simulation circuit, a node between the two series-connected A type internal ear canal impedances Z_{ECA} is connected with a B type internal ear canal impedance Z_{ECB}. Wherein, formulas of the A type internal ear canal impedance and the B type internal ear canal impedance are shown as the followings:

$$\begin{matrix}{Z}_{ECA} = {jZ}_{0} tan ( \frac{{kL}_{EC}}{2} ) & ( 7 ) \\ {Z}_{ECB} = \frac{{Z}_{0}}{j sin ( {KL}_{EC} )} \\ and & ( 8 ) \\ {Z}_{0} = \frac{{ρ}_{0} C}{{a}_{EC}^{2} π} & ( 9 )\end{matrix}$$

In the formulas (7), (8) and (9), a_{EC} is the cross-sectional radius of the internal ear canal; ρ₀ is air density; c is acoustic speed.

Before simulating the whole operation of the earphone by using the EMA analog circuit, we need to set T-S parameters in the EMA analog circuit first for simulating the microspeaker of the earphone. Wherein, the T-S parameters are obtained via an electrical impedance measurement conducted in an experiment. In the present invention, the earphone acoustic simulation system is used as an acoustic system of the EMA analog circuit. Therefore, in case that it is desired to simulate variations of cavity structure in the earphone, the designer can achieve the variations by adjusting the resistance, the capacitance and the impedance corresponding to the structure of the simulated earphone cavity, and also by getting the frequency response of the earphone, namely a sound pressure level (SPL) curve from the earphone acoustic simulation system. The SPL curve consists of points of voltage values outputted from the B type internal ear canal impedance of the ear canal simulation circuit.

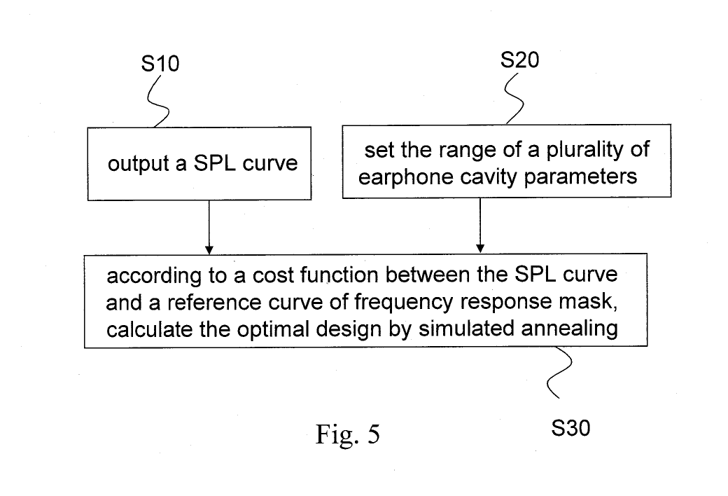

As mentioned above, the present invention proposes the earphone acoustic simulation system corresponding to numerical design of the earphone cavity. An optimal parameter of the earphone cavity can be anticipated according to the SPL curve outputted from the ear canal simulate circuit. Refer to FIG. 5 for an optimal simulation method for the earphone acoustic simulation system according to the present invention. Firstly, acquire the SPL curve from the earphone acoustic simulation system, as shown in the step of S10. Next, set the range of a plurality of earphone cavity parameters, as shown in the step of S20. For example, the cross-sectional radius of the duct a_{SP}, the length of the duct L_{SP}, the volumes of the front cavity and the back cavity V_{AF}, V_{AB} are the characteristic parameters of the earphone cavity structure. Also, the above mentioned parameters are variable and constraint in the following ranges:

2×10⁻⁴≦α_{SP}≦3×10⁻³

10⁻³≦L_{SP}≦10⁻²

2×10⁻⁹≦V_{AF}≦9×10⁻⁸

2×10⁻⁹≦V_{AB}≦9×10⁻⁸

Then, generate an optimal parameter of the earphone cavity according to a cost function between the SPL curve and a reference curve of a frequency response mask, as shown in the step of S30. The cost function is as shown in the following formula (10):

$$Q = {\sum }_{n = 1}^{N} {[ {SPL}_{new} ( n ) - {L}_{ref} ( n ) ]}^{2} \qquad ( 10 )$$

where SPL_{new}(n) represents the SPL curve, L_{ref}(n) represents the reference curve of frequency response mask, n represents the frequency index within the band 20-4500 Hz, and N is natural number. Also, an initial temperature, a final temperature and rate of the decreasing temperature are set before executing simulated annealing method. Moreover, in a simulated annealing, use a variable success probability function P to determine if a new solution can replace an old solution or to keep the old solution. In other words, acceptance of new solutions depends on the variable success probability function P obtained through a simulated annealing. The function P is as shown in formula (11):

$$P = exp ( \frac{Δ Q}{T} ) > γ ( 0 , 1 ) \qquad ( 11 )$$

where ΔQ is the increase amount of the cost function, T is a control parameter, which by analogy is known as the system “temperature” irrespective of the cost function involved, and γ(0,1) is a random number generated in the interval (0,1). Therefore, through the above four steps, acquire a SPL curve related to the optimal solution of the earphone parameter, such that the SPL curve is in conformity with the requirement in 3GPP2 C.S0056-0, and obtain the optimal parameter of the earphone cavity from the optimal solution.

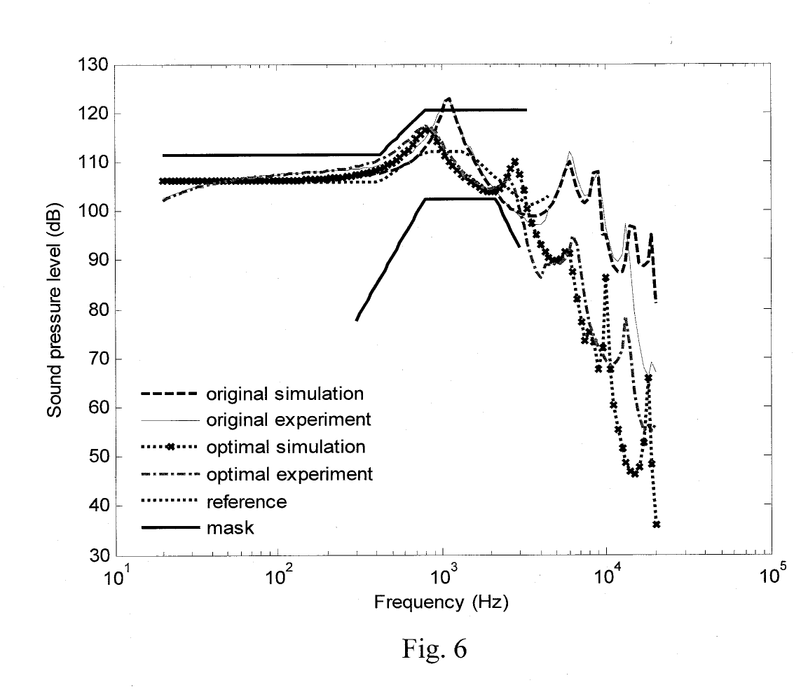

Refer to FIG. 6 for a diagram of an original simulation SPL curve, an original experiment SPL curve, an optimal simulation SPL curve and an optimal experiment SPL curve in an experiment and a simulation according to the present invention. As shown in FIG. 6, in a mask frequency range, the original simulation curve acquired from the earphone acoustic simulation system according to the present invention is similar to the original experiment curve. As opposed to the original non-optimized design, and after the optimization of simulated annealing, the optimized design effectively lowers the resonance peak to be within the frequency response mask of 3GPP2. Therefore, the earphone cavity parameters related to the optimal simulation SPL curve is suitable for bluetooth earphone design.

Therefore, in the present invention, the EMA analog circuit is used to simulate the electrical system, the mechanical system and the acoustic system in an earphone, and as a result the frequency response in the earphone. The simulated annealing method is utilized to calculate the optimal parameter for the earphone cavity design. The simulated annealing method is a random-search technique which exploits an analogy between the ways in which a metal cools and freezes into a minimum energy crystalline structure, and the variable success probability function is utilized to process calculation for the optimal solution which is not only in a specific range, such that we can search for the optimal parameter of earphone cavity by the earphone acoustic simulation system according to the present invention, and the SPL curve is acquired from the ear canal simulation circuit of the artificial ear simulation circuit.

As mentioned above, the earphone acoustic simulation system of the present invention is used to simulate the acoustic environment inside the earphone cavity. The simulated earphone cavity structure can be varied with the different values of the impedances, the capacitances and the resistances. Besides, the simulated annealing method is used to calculate the optimal parameter for the earphone cavity in cooperation with the earphone acoustic simulation system. As a result, when designing the earphone structure, the designer can anticipate the result of the frequency response of an earphone.

Those described above are only the preferred embodiments to clarify the technical contents and characteristic of the present invention in enabling the persons skilled in the art to understand, make and use the present invention. However, they are not intended to limit the scope of the present invention. Any modification and variation according to the spirit of the present invention can also be included within the scope of the claims of the present invention.

What is claimed is:

1. An earphone acoustic simulation system, comprising:
an acoustic source, comprising a positive output terminal and a negative output terminal to output an acoustic signal;
an earphone front end simulation circuit, is formed by a front cavity simulation circuit and a duct simulation circuit connected in parallel, wherein said earphone front end simulation circuit is connected with said positive output terminal, and receives said acoustic signal and outputs a voltage signal;
an artificial ear simulation circuit, is formed by an ear canal simulation circuit and an artificial ear simulator connected to each other, and is used to connect with said earphone front end simulation circuit, and receive said voltage signal, and said ear canal simulation circuit outputs impedance voltages; and
an earphone back end simulation circuit, is formed by a back cavity simulation circuit and a leakage hole simulation circuit connected in parallel, and said earphone back end simulation circuit is connected with said negative output terminal and said artificial ear simulation circuit, and is used to transmit said voltage signal back to said acoustic source.

2. The earphone acoustic simulation system according to claim 1, wherein said duct simulation circuit comprises a first resistor and a duct transmission line T-circuit connected to each other for simulating a duct in an earphone.

3. The earphone acoustic simulation system according to claim 2, wherein a formula of said first resistance
$$( {R}_{ST} ) is \frac{{ρ}_{0}}{π {a}_{ST}} \sqrt{2 ωμ} ( \frac{{L}_{ST}}{{a}_{ST}} + 2 ) ,$$
wherein L_{ST} is a length of said duct, a_{ST} is a radius of said duct, and μ is dynamic viscosity.

4. The earphone acoustic simulation system according to claim 2, wherein said duct transmission line T-circuit comprises two A type duct impedances and one B type duct impedance connected together.

5. The earphone acoustic simulation system according to claim 4, wherein a formula of said A type duct impedance (Z_{STA}) is
$${jZ}_{0} tan ( \frac{{kL}_{ST}}{2} ) ,$$
a formula of said B type impedance (Z_{STB}) is
$$\frac{{Z}_{0}}{j sin ( {kL}_{ST} )} ,$$
wherein L_{ST} is a length of said duct, Z₀ is
$$\frac{{ρ}_{0} c}{{a}_{ST}^{2} π} ,$$
a_{ST} is a radius of said duct, ρ₀ is air density, and c is acoustic speed.

6. The earphone acoustic simulation system according to claim 1, wherein said front cavity simulation circuit is a first capacitor for simulating a front cavity of an earphone.

7. The earphone acoustic simulation system according to claim 6, wherein a formula of said first capacitance (C_{AF}) is
$$\frac{{V}_{A}}{{ρ}_{0} {c}^{2}} ,$$
ρ₀ is air density, c is acoustic speed and V_{A} is volume of said front cavity.

8. The earphone acoustic simulation system according to claim 1, wherein said ear canal simulation circuit comprises an external ear canal simulation circuit and an internal ear canal simulation circuit.

9. The earphone acoustic simulation system according to claim 8, wherein said external ear canal simulation circuit is an external ear canal transmission line T-circuit, comprising two A type external ear canal impedances and one B type external ear canal impedance connected together, for simulating an external ear of an artificial ear.

10. The earphone acoustic simulation system according to claim 9, wherein said A type external ear canal impedance (Z_{AEA}) is equal to
$${jZ}_{0} tan ( \frac{{kL}_{AE}}{2} ) ,$$
said B type external ear canal impedance (Z_{AEB}) is equal to
$$\frac{{Z}_{0}}{j sin ( {kL}_{AE} )} ,$$
L_{AE} is length of said external ear canal, Z₀ is
$$\frac{{ρ}_{0} C}{{a}_{AE}^{2} π} ,$$
a_{AE} is radius of said external ear canal, ρ₀ is air density, and c is acoustic speed.

11. The earphone acoustic simulation system according to claim 8, wherein said internal ear canal simulation circuit is an internal ear canal transmission line T-circuit, comprising two A type internal ear canal impedances and one B type internal ear canal impedance connected together, for simulating an internal ear canal of an artificial ear.

12. The earphone acoustic simulation system according to claim 11, wherein said impedance voltage is a voltage value of said B type internal ear canal impedance.

13. The earphone acoustic simulation system according to claim 11, wherein said internal ear canal simulation circuit further comprises an eardrum impedance, with an infinite impedance value for simulating said artificial ear as a close environment.

14. The earphone acoustic simulation system according to claim 11, wherein said A type internal ear canal impedance (Z_{ECA}) is
$${jZ}_{0} tan ( \frac{{kL}_{EC}}{2} ) ,$$
said B type internal ear canal impedance (Z_{ECB}) is
$$\frac{{Z}_{0}}{j sin ( {kL}_{EC} )} ,$$
wherein L_{EC} is length of said internal ear canal, Z₀ is
$$\frac{{ρ}_{0} C}{{a}_{EC}^{2} π} ,$$
a_{EC} is radius of said internal ear canal, ρ₀ is air density, and c is acoustic speed.

15. The earphone acoustic simulation system according to claim 1, wherein said leakage hole simulation circuit comprises a second resistance connected with a first inductor for simulating a leakage hole of an earphone.

16. The earphone acoustic simulation system according to claim 15, wherein said first inductor (M_{LK}) is
$$\frac{{ρ}_{0}}{{S}_{LK}} {L}_{LK} ,$$
S_{LK} is cross-section area of said leakage hole, and L_{LK} is length of a back duct of said earphone.

17. The earphone acoustic simulation system according to claim 15, wherein said leakage hole simulation circuit further comprises a second inductor and a third resistor connected in parallel, for simulating acoustic radiation in said leakage hole of said earphone.

18. The earphone acoustic simulation system according to claim 1, wherein said artificial ear simulator is an IEC711 simulator.

19. The earphone acoustic simulation system according to claim 1, wherein said back cavity simulation circuit is a second capacitor for simulating a back cavity of an earphone.

20. The earphone acoustic simulation system according to claim 19, wherein said second capacitor (C_{AB}) is
$$\frac{{V}_{B}}{{ρ}_{0} {c}^{2}} ,$$
ρ₀ is air density, c is acoustic speed and V_{B} is volume of said back cavity.

21. The earphone acoustic simulation system according to claim 2, wherein said earphone is a bluetooth earphone.

22. The earphone acoustic simulation system according to claim 6, wherein said earphone is a bluetooth earphone.

23. The earphone acoustic simulation system according to claim 15, wherein said earphone is a bluetooth earphone.

24. The earphone acoustic simulation system according to claim 19, wherein said earphone is a bluetooth earphone.

25. An optimal simulation method of an earphone acoustic simulation system, comprising steps of:
establishing an Electro-Mechanical-Acoustical (EMA) analog circuit comprising said earphone acoustic simulation system where an acoustic source used to transmit an acoustic signal to an earphone front end simulation circuit, said earphone front end simulation circuit outputs a voltage signal to an artificial ear simulation circuit, and then said voltage signal is output by said artificial simulation circuit through an earphone back end simulation circuit back to said acoustic source;
setting range of a plurality of earphone cavity parameters, outputting impedance voltages from said artificial ear simulation circuit, and acquiring a sound pressure level (SPL) curve; and
calculating by simulated annealing method to generate optimal earphone cavity parameters according to a cost function between said SPL curve and a reference curve of frequency response mask.

26. The optimal simulation method according to claim 25, wherein said earphone cavity parameters comprises cross-section radius of a duct, length of said duct, volume of a front cavity and volume of a back cavity.

27. The optimal simulation method according to claim 25, wherein said ranges of said earphone cavity parameters are as follows:
said cross-section radius of said duct is greater than or equal to 2×10⁻⁴, and less than or equal to 3×10⁻³;
said length of said duct is greater than or equal to 10⁻³, and less than or equal to 10⁻²;
said volume of said front cavity is greater than or equal to 2×10⁻⁹, and less than or equal to 9×10⁻⁸; and
said volume of said back cavity is greater than or equal to 2×10⁻⁹, and less than or equal to 9×10⁻⁸.

28. The optimal simulation method according to claim 25, wherein said cost function is
$$Q = {\sum }_{n = 1}^{N} {[ {SPL}_{new} ( n ) - {L}_{ref} ( n ) ]}^{2} ,$$
wherein said SPL_{new}(n) is said SPL curve, said L_{ref}(n) is said reference curve of said frequency response mask, n is frequency index, N is natural number, and frequency range of said SPL curve is set from 20 Hz to 4500 Hz.

29. The optimal simulation method according to claim 25, wherein said step of calculating by said simulated annealing method to generate said optimal earphone cavity parameters according to said cost function between said SPL curve and said reference curve of said frequency response mask further comprises said step of:
using a variable success probability function, which is
$$P = exp ( \frac{Δ Q}{T} ) > γ ( 0 , 1 ) ,$$
to determine if a new solution replace an old solution, wherein ΔQ is increase in said cost function, T is system temperature irrespective of said cost function, and γ(0,1) is a random number generated in interval (0,1).

30. The optimal simulation method according to claim 25, wherein said step of calculating by said simulated annealing method to generate said optimal earphone cavity parameters according to said cost function between said SPL curve and said reference curve of said frequency response mask further includes said step of:
setting an initial annealing temperature, a final annealing temperature and a rate of decreasing temperature of said simulated annealing method.
